(19) United States
(12) Patent Application Publication
(10) Pub. No.: US 2026/0011921 A1
(43) Pub. Date: Jan. 8, 2026

(54) SUBSTRATE STRUCTURAL UNIT, ANTENNA MODULE, AND COMMUNICATION DEVICE

(71) Applicant: Murata Manufacturing Co., Ltd., Nagaokakyo-shi (JP)

(72) Inventors: Yosuke SATO, Nagaokakyo-shi (JP); Kengo ONAKA, Nagaokakyo-shi (JP); Kaoru SUDO, Nagaokakyo-shi (JP)

(73) Assignee: Murata Manufacturing Co., Ltd., Nagaokakyo-shi (JP)

(21) Appl. No.: 19/328,389

(22) Filed: Sep. 15, 2025

Related U.S. Application Data
(63) Continuation of application No. PCT/JP2024/014525, filed on Apr. 10, 2024.

(30) Foreign Application Priority Data
Apr. 11, 2023 (JP) 2023-064085

(51) Int. Cl. H01Q 9/04; H01Q 1/22; H01Q 1/48

(52) U.S. Cl. CPC H01Q 9/0407; H01Q 1/22; H01Q 1/48

(57) ABSTRACT

A substrate structural unit includes substrates each having a flat plate shape and at least one conductive member. Each of the substrates includes a first main surface and a second main surface opposed to each other and side surfaces connecting the first main surface and the second main surface. The conductive member is exposed on a side surface of the substrate. The substrate is attached to the substrate such that the normal direction of a main surface of the substrate differs from the normal direction of a main surface of the substrate. The substrate is electrically connected to the substrate by the conductive member.

### CROSS-REFERENCE TO RELATED APPLICATIONS

This is a continuation application of PCT International Patent Application No. PCT/JP2024/014525 filed on Apr. 10, 2024, which claims priority to Japanese patent application JP 2023-064085, filed Apr. 11, 2023, the entire contents of each of which being incorporated herein by reference.

### TECHNICAL FIELD

The present disclosure relates to substrate structural units, antenna modules, and communication devices and more particularly to a technique for downsizing antenna modules.

### BACKGROUND ART

International Publication No. 2020/170722 (Patent Document 1) discloses an antenna module in which a bent dielectric substrate has flat portions with different normal directions, and radiating elements are located on the flat portions. The antenna module disclosed in International Publication No. 2020/170722 (Patent Document 1) is capable of radiating radio waves in two different directions.

### CITATION LIST

### Patent Document

Patent Document 1: International Publication No. 2020/170722

### SUMMARY

### Technical Problems

Some antenna modules as mentioned above are used in mobile communication devices typified by mobile phones and smartphones. In such mobile communication devices, downsizing of the device itself and/or high-density integration of internal components requires a further reduction in the size and height of the antenna module.

Since the antenna module disclosed in International Publication No. 2020/170722 (Patent Document 1) is formed by bending a dielectric substrate in a flat plate shape, the two substrates on which radiating elements are located are connected by the bent portion. In such configuration, the bent portion between the two substrates forms a space, resulting in a dead space. Hence, the configuration of the antenna module disclosed in International Publication No. 2020/170722 (Patent Document 1) still has potential for further downsizing.

The present disclosure has been made to address such and other challenges, and is directed to providing a technique, applicable to antenna modules, that enables downsizing of a substrate structural unit including two substrates having different normal directions.

### Solutions to Problems

A substrate structural unit according to a perspective of the present disclosure includes a first substrate and a second substrate each having a flat plate shape, and at least one first conductive member. Each of the first substrate and the second substrate includes a first main surface and a second main surface opposed to each other and side surfaces connecting the first main surface and the second main surface. The first conductive member is exposed on a side surface of the first substrate. The first substrate is attached to the second substrate such that the normal direction of the first main surface of the first substrate differs from the normal direction of the first main surface of the second substrate. The first substrate is electrically connected to the second substrate by the at least one first conductive member.

An antenna module according to another perspective of the present disclosure includes a first substrate and a second substrate each having a flat plate shape, a first radiating element located on or in the first substrate, and at least one first conductive member. Each of the first substrate and the second substrate includes a first main surface and a second main surface opposed to each other and side surfaces connecting the first main surface and the second main surface. The first conductive member is exposed on a first side surface of the first substrate. The first substrate is attached to the second substrate such that the normal direction of the first main surface of the first substrate differs from the normal direction of the first main surface of the second substrate. The first substrate is electrically connected to the second substrate by the at least one first conductive member.

### Advantageous Effects

In the substrate structural unit and the antenna module to which the substrate structural unit is applied, according to the present disclosure, the conductive member (the first conductive member) is exposed on a side surface of the first substrate of the two substrates (the first substrate, the second substrate) each having a flat plate shape, and the two substrates are connected by using the conductive member such that the normal lines of the two substrates are oriented differently. This configuration enables two substrates to be connected without a dead space. Thus, it is possible to provide a technique, applicable to antenna modules, that enables downsizing of a substrate structural unit including two substrates having different normal directions.

### BRIEF DESCRIPTION OF DRAWINGS

FIG. 1 is an overall schematic diagram of a communication device to which an antenna module of Embodiment 1 is applied.

FIG. 2 is a perspective view of the antenna module according to Embodiment 1.

FIG. 3 illustrates a side transparent view of the antenna module in FIG. 2 as viewed in the Y-axis direction and a side view in the X-axis direction.

FIG. 4 illustrates diagrams for explaining examples of side vias.

FIG. 5 illustrates a side transparent view of an antenna module of Modification Example 1 as viewed in the Y-axis direction and a side view in the X-axis direction.

FIG. 6 is a side transparent view of an antenna module of Modification Example 2 as viewed in the Y-axis direction.

FIG. 7 illustrates a side transparent view of an antenna module of Modification Example 3 as viewed in the Y-axis direction and a side view in the X-axis direction.

FIG. 8 illustrates a side transparent view of an antenna module of Modification Example 4 as viewed in the Y-axis direction and a side view in the X-axis direction.

FIG. 9 illustrates a side transparent view of an antenna module of Modification Example 5 as viewed in the Y-axis direction and a side view in the X-axis direction.

FIG. 10 illustrates a side transparent view of an antenna module of Modification Example 6 as viewed in the Y-axis direction and a side view in the X-axis direction.

FIG. 11 illustrates a side transparent view of an antenna module of Modification Example 7 as viewed in the Y-axis direction and a side view in the X-axis direction.

FIG. 12 is a side transparent view of an antenna module of Modification Example 8 as viewed in the Y-axis direction.

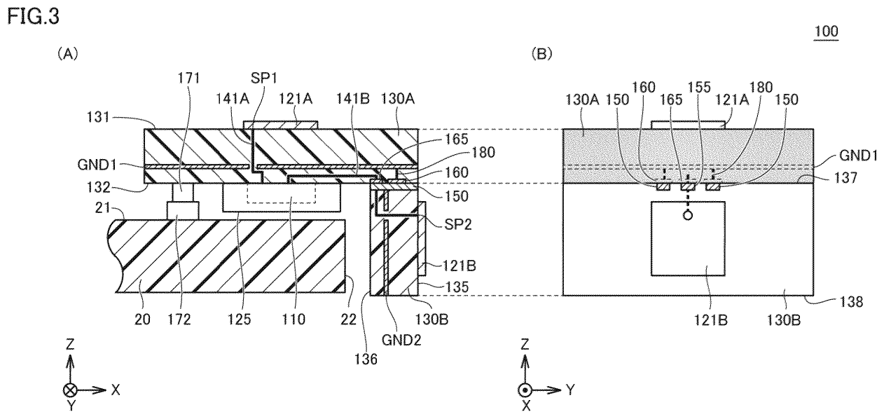

FIG. 3 illustrates a side transparent view of an antenna module according to Embodiment 2 as viewed in the Y-axis direction and a side view in the X-axis direction.

FIG. 14 illustrates a side transparent view of an antenna module according to Embodiment 3 as viewed in the Y-axis direction and a side view in the X-axis direction.

FIG. 15 is a side transparent view of an antenna module according to Embodiment 4 as viewed in the Y-axis direction.

FIG. 16 is a side transparent view of an antenna module according to Modification Example 9 as viewed in the Y-axis direction.

FIG. 17 is a side view of an antenna module according to Embodiment 5 as viewed in the X-axis direction.

FIG. 18 is a side view of an antenna module according to Modification Example 10 as viewed in the X-axis direction.

FIG. 19 is a side transparent view of an antenna module according to Modification Example 11 as viewed in the Y-axis direction.

FIG. 20 is a side transparent view of an antenna module according to Modification Example 12 as viewed in the Y-axis direction.

### DESCRIPTION OF EMBODIMENTS

Hereinafter, embodiments of the present disclosure will be described in detail with reference to the drawings. Note that the same or similar portions in figures are denoted by the same reference signs without repetitive description thereof.

### Embodiment 1

### Basic Configuration of Communication Device

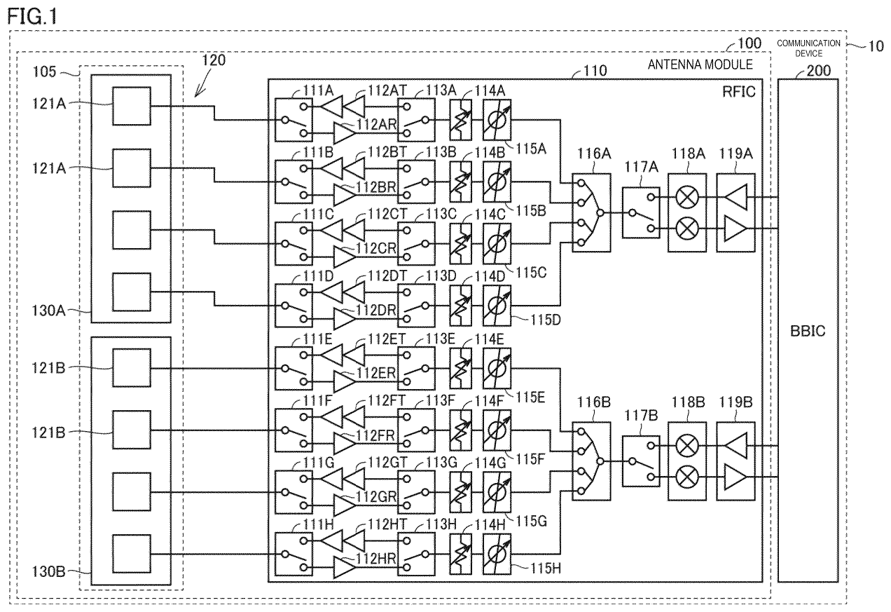

FIG. 1 is a block diagram of a communication device 10 to which an antenna module 100 according to Embodiment 1 is applied. The communication device 10 is, for example, a mobile terminal such as a mobile phone, a smartphone, or a tablet; a personal computer with a communication function; or the like. An example of the frequency band of the radio waves used in the antenna module 100 according to Embodiment 1 is, for example, radio waves in a millimeter wave band with a center frequency of 28 GHz, 39 GHz, or 60 GHz. However, the present disclosure is also applicable to radio waves of frequency bands other than the above.

As illustrated in FIG. 1, the communication device 10 includes the antenna module 100 and a BBIC 200 serving as a base-band signal processing circuit. The antenna module 100 includes an RFIC 110, which is an example of a power supply circuit, and an antenna device 120. The communication device 10 upconverts the signals conveyed from the BBIC 200 to the antenna module 100 into high frequency signals, which are radiated from the antenna device 120. The communication device 10 also downconverts the high frequency signals received by the antenna device 120, and the resultant signals are processed by the BBIC 200.

The antenna device 120 includes a dielectric substrate (a substrate structural unit) 105 including two substrates 130A and 130B. Each substrate of the dielectric substrate 105 has at least one radiating element. FIG. 1 illustrates an example of a configuration in which the substrate 130A has four radiating elements 121A, and the substrate 130B has four radiating elements 121B. However, the number of radiating elements arranged in each substrate is not limited to this example. In addition, FIG. 1 illustrates an example in which the radiating elements in each substrate of the dielectric substrate are arranged in a row, in other words, in the form of a one-dimensional array. However, the radiating elements in each substrate may be arranged in the form of a two-dimensional array. Alternatively, each substrate may have a single radiating element. In Embodiment 1, each of the radiating elements 121A and 121B is a patch antenna having a flat plate shape that is approximately square.

The RFIC 110 includes switches 111A to 111H, 113A to 113H, 117A, and 117B, power amplifiers 112AT to 112HT, low-noise amplifiers 112AR to 112HR, attenuators 114A to 114H, phase shifters 115A to 115H, signal combiners/splitters 116A and 116B, mixers 118A and 118B, and amplification circuits 119A and 119B. Among these, the switches 111A to 111D, 113A to 113D, and 117A, the power amplifiers 112AT to 112DT, the low-noise amplifiers 112AR to 112DR, the attenuators 114A to 114D, the phase shifters 115A to 115D, the signal combiner/splitter 116A, the mixer 118A, and the amplification circuit 119A are the circuits for the high frequency signals that are radiated from the radiating elements 121A on the substrate 130A. The switches 111E to 111H, 113E to 113H, and 117B, the power amplifiers 112ET to 112HT, the low-noise amplifiers 112ER to 112HR, the attenuators 114E to 114H, the phase shifters 115E to 115H, the signal combiner/splitter 116B, the mixer 118B, and the amplification circuit 119B are the circuits for the high frequency signals that are radiated from the radiating elements 121B on the substrate 130B.

When high frequency signals are transmitted, the switches 111A to 111H and 113A to 113H are switched to the power amplifiers 112AT to 112HT, and the switches 117A and 117B are connected to the transmission amplifiers of the amplification circuits 119A and 119B. When high frequency signals are received, the switches 111A to 111H and 113A to 113H are switched to the low-noise amplifiers 112AR to 112HR, and the switches 117A and 117B are connected to the reception amplifiers of the amplification circuits 119A and 119B.

The signals conveyed from the BBIC 200 are amplified by the amplification circuits 119A and 119B and then upconverted by the mixers 118A and 118B. The transmission signals, which are upconverted high frequency signals, are quadruply split by the signal combiners/splitters 116A and 116B, and each of the resultant signals passes through the corresponding signal path and is supplied to a different one of the radiating elements 121A and 121B. The phase shift degrees of the phase shifters 115A to 115H located on different signal paths are individually adjusted, so that the directivity of the radio waves output from the radiating elements of each substrate can be adjusted. The attenuators 114A to 114D are used to adjust the strength of transmission signals.

The reception signals, which are high frequency signals, received by the radiating elements 121A and 121B are conveyed to the RFIC 110, pass through different sets of four signal paths, and are combined at the signal combiners/splitters 116A and 116B. The combined reception signals are downconverted by the mixers 118A and 118B, then amplified by the amplification circuits 119A and 119B, and conveyed to the BBIC 200.

The RFIC 110 is, for example, a one-chip integrated circuit component including the circuit configuration described above. Alternatively, the elements (switches, power amplifier, low-noise amplifier, attenuator, and phase shifter) associated with each of the radiating elements 121A and 121B in the RFIC 110 may be formed as a one-chip integrated circuit component for each associated radiating element.

### Configuration of Antenna Module

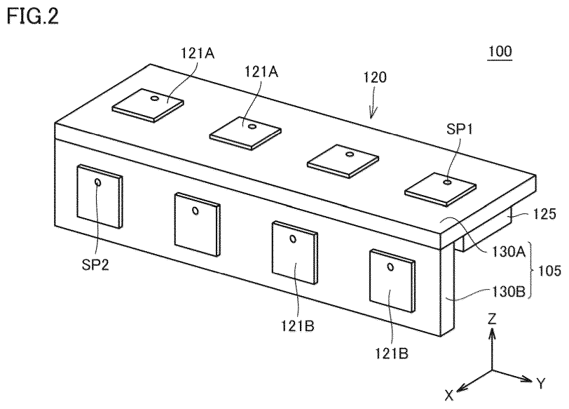

Next, details of the configuration of the antenna module 100 of Embodiment 1 will be described with reference to FIGS. 2 and 3. FIG. 2 is a perspective view of the antenna module 100. FIG. 3 illustrates a side transparent view (the left figure (A)) of the antenna module 100 mounted on a mounting substrate 20 as viewed in the Y-axis direction and a side view (the right figure (B)) in the X-axis direction. In the following description, the side views in the X-axis direction are based on an example including one radiating element 121B, except FIGS. 17 and 18, for ease of explanation.

As illustrated in FIGS. 2 and 3, the antenna module 100 also includes power supply lines 141A and 141B, a connector 171, and ground electrodes GND1 and GND2, in addition to the dielectric substrate 105 (the substrates 130A and 130B), the radiating elements 121A and 121B, and the RFIC 110. In the following description, the normal direction of the substrate 130A corresponds to the Z-axis direction, the normal direction of the substrate 130B corresponds to the X-axis direction, and the arrangement direction of the radiating elements on each substrate corresponds to the Y-axis direction. In each figure, the positive direction of the Z-axis is sometimes referred to as the upper surface side, and the negative direction of the Z-axis as the lower surface side.

The dielectric substrate 105 is, for example, a multilayer resin substrate including a plurality of laminated resin layers each composed of a resin such as epoxy and polyimide, a multilayer resin substrate including a plurality of laminated resin layers each composed of a liquid crystal polymer (LCP) having lower permittivity, or a multilayer resin substrate including a plurality of laminated resin layers each composed of a fluorine-based resin. Note that the dielectric substrate 105 is not limited to having a multilayer structure and may be a single-layer substrate.

Regarding the antenna device 120 of the antenna module 100, the cross-sectional shape of the dielectric substrate 105 viewed in the Y-axis direction is approximately L-shaped, and the substrate 130B having a flat plate shape whose normal direction corresponds to X-axis direction is connected to the substrate 130A having a flat plate shape whose normal direction corresponds to the Z-axis direction. The substrate 130A includes main surfaces 131 and 132 opposed to each other. The substrate 130B includes main surfaces 135 and 136 opposed to each other. In the following description, the main surface 131 of the substrate 130A is sometimes referred to as “the upper surface”, and the main surface 132 as “the lower surface”.

In the antenna module 100, each of the two substrates 130A and 130B has four radiating elements arranged in a row in the Y-axis direction. For ease of understanding, the following description is based on an example in which the radiating elements 121A and 121B are exposed on the main surfaces 131 and 135 of the substrates 130A and 130B, respectively. However, the radiating elements 121A and 121B may be located in the substrates 130A and 130B, respectively.

The substrate 130A is approximately rectangular in plan view in the Z-axis direction, and the four radiating elements 121A are arranged in a row in the Y-axis direction on the surface of the substrate 130A. The lower surface 132 (the surface facing the negative direction of the Z-axis) of the substrate 130A has the connector 171 and a SiP (system in package) module 125 containing the RFIC 110, a power module IC, and other components. In addition, the substrate 130A has the ground electrode GND1 located in the layer between the radiating elements 121A and the lower surface 132.

The substrate 130A is mounted on the mounting substrate 20 by the connector 171 being connected to a connector 172 located on a surface 21 of the mounting substrate 20. Note that the substrate 130A may be mounted on the mounting substrate 20 by solder connection. Alternatively, the substrate 130A may be mounted on the mounting substrate 20 by the RFIC 110 being bonded to the mounting substrate 20 with a thermal interface material (TIM) interposed therebetween. In this case, the connector 171 may be connected to a connector 172 located on another board such as a flexible board.

The substrate 130B is approximately rectangular in plan view in the X-axis direction, and the main surface 136 of the substrate 130B facing the negative direction of the X-axis faces a side surface 22 of the mounting substrate 20. The side surface of the substrate 130B facing the positive direction of the Z-axis is connected to an end portion of the lower surface 132 of the substrate 130A in the positive direction of the X-axis. On the main surface 135 of the substrate 130B, the four radiating elements 121B are arranged in a row in the Y-axis direction. In addition, the substrate 130B has the ground electrode GND2 located in the layer between the radiating elements 121B and the main surface 136.

Each radiating element 121A of the substrate 130A has a power supply point SP1 to which high frequency signals are conveyed from the RFIC 110 in the SiP module 125 through the power supply line 141A. The power supply point SP1 of each radiating element 121A is positioned in the negative direction of the X-axis relative to the center of the radiating element 121A. When high frequency signals are supplied to the power supply point SP1, the radiating element 121A radiates radio waves with the polarization direction along the X-axis in the positive direction of the Z-axis.

Each radiating element 121B of the substrate 130B receives high frequency signals conveyed from the RFIC 110 through the power supply line 141B. The power supply line 141B extends from the RFIC 110 through the inside of the substrates 130A and 130B and is connected to a power supply point SP2 of each radiating element 121B located on the substrate 130B. The power supply point SP2 of each radiating element 121B is positioned in the positive direction of the Z-axis relative to the center of the radiating element 121B. When high frequency signals are supplied to the power supply point SP2, the radiating element 121B radiates radio waves with the polarization direction along the Z-axis in the positive direction of the X-axis.

The portion of the substrate 130B connected to the substrate 130A has conductive members 150 and 155 for electrically connecting the substrate 130A and the substrate 130B. The conductive members 150 and 155 are electrodes extending in the lamination direction of the substrate 130B (the Y-axis direction) and are exposed on the side surface 137 of the substrate 130B facing the positive direction of the Z-axis. In the following description, the conductive members 150 and 155 are sometimes referred to as “the side vias”.

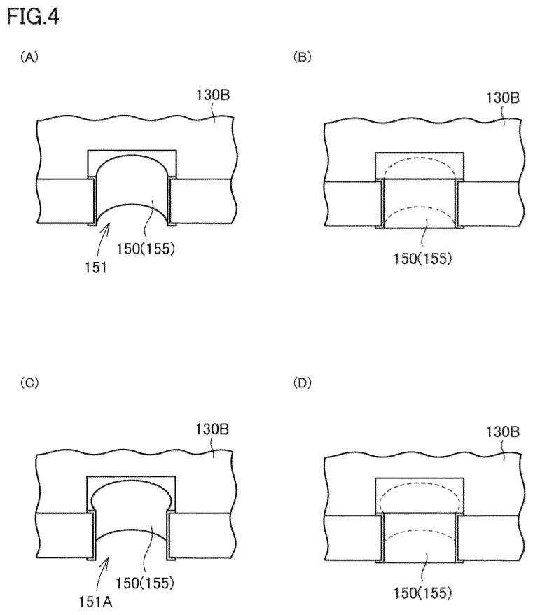

FIG. 4 illustrates diagrams showing specific structure examples of the side vias (the conductive members 150 and 155). The side via in the example in the upper left figure (A) has a configuration in which a semicircular through hole 151 is formed on the side surface 137 of the substrate 130B, and a conductive material such as copper, solder, or conductive paste is provided on the inner side surface of the through hole 151. The side via in the example in the upper right figure (B) is a pillar electrode in which the through hole 151 mentioned above is filled with a conductive material. Note that as illustrated in the lower left figure (C) and the lower right figure (D) in FIG. 4, a through hole 151A may have an arch shape with an angle larger than 180°. In the case in which the through hole 151A has a shape mentioned above, when the side via is attached with solder or the like, the side via serves an anchor function, making it less likely for the side via to come off from the through hole 151A. As used herein, ‘attached’ refers to the mechanical and electrical coupling of one substrate to another, which may be achieved by methods including, but not limited to, soldering, adhesive bonding, or fitting into a recess, or a combination thereof.

Although all examples in FIG. 4 show configurations in which the side via extend through the substrate 130B from the main surface 135 to the main surface 136, extending through the substrate 130B is not indispensable. A configuration in which at least one of the end portions of the side via in the X-axis direction is not exposed on the corresponding main surface is also possible. Unnecessary conductive material in the through hole 151 or 151A may be removed by back drilling or other methods. In particular, regarding the conductive member 155 which is the side via connected to the power supply line 141B, the depth of the through hole 151 or 151A and/or the position of the conductive material in the through hole 151 or 151A is adjusted as appropriate so that the conductive member 155 is not short-circuited with a ground electrode.

As illustrated again in FIG. 3, the lower surface 132 of the substrate 130A has electrode pads 160 and 165 associated with the conductive members 150 and 155 of the substrate 130B. The conductive members 150 and the electrode pads 160 are electrodes for electrically connecting the ground electrode GND1 of the substrate 130A and the ground electrode GND2 of the substrate 130B. The electrode pads 160 are connected to the ground electrode GND1 with vias 180 interposed therebetween in the substrate 130A. The conductive members 150 are connected to the ground electrode GND2 in the substrate 130B.

The conductive member 155 and the electrode pad 165 are electrodes for connecting a portion of the power supply line 141B in the substrate 130A and a portion of the power supply line 141B in the substrate 130B. A portion of the power supply line 141B in the substrate 130A is connected to the electrode pad 165. A portion of the power supply line 141B in the substrate 130B is connected to the conductive member 155. The conductive members 150 and 155 are connected to the electrode pads 160 and 165 with conductive connection members such as solder.

The connection between the conductive members 150 and 155 and the electrode pads 160 and 165 establishes the electrical connection between the substrate 130A and the substrate 130B and also fixes the substrate 130B to the substrate 130A. Note that to improve the mechanical connection strength between the substrate 130A and the substrate 130B, the dielectric portions of the two substrates may be bonded with an adhesive or the like, in addition to solder connection.

Note that the conductive member 155 for the power supply line is located between the two conductive members 150 for the ground electrodes. With this arrangement, the conductive member 155 functions as a so-called coplanar line. This configuration enables the impedance of the conductive member 155 to be maintained at a specific impedance, reducing the insertion loss and return loss.

As an antenna module capable of radiating radio waves in two different directions as described above, a configuration has been known in which part of a dielectric substrate having a flat plate shape is bent as disclosed in International Publication No. 2020/170722 (Patent Document 1). Since such a configuration includes a bent portion connecting two flat portions having different normal directions, the overall shape is such that one flat portion further protrudes from an end portion in the extending direction of the flat portion. In the case in which the downsizing trend of communication devices requires the antenna module itself to be further downsized, the dead space resulting from this protruding shape can be a factor of hindering downsizing.

Unlike the above configuration, the antenna module 100 of Embodiment 1 includes the dielectric substrate 105 including the two substrates 130A and 130B having different normal directions, and the two substrates are connected by using the conductive members (the side vias) 150 and 155 exposed on a side surface of the substrate 130B. With the configuration described above, as illustrated in the left figure (A) in FIG. 3, the amount of protrusion of the substrate 130B from the end portion of the substrate 130A in the X-axis direction can be smaller than the bent structure as in Patent Document 1. Thus, the use of a dielectric substrate structure as in Embodiment 1 enables downsizing of antenna modules.

Note that “the substrate 130B” and “the substrate 130A” in Embodiment 1 correspond to “a first substrate” and “a second substrate”, respectively, in the present disclosure. “The main surface 135” and “the main surface 136” of the substrate 130B in Embodiment 1 correspond to “a first main surface” and “a second main surface”, respectively, of the first substrate in the present disclosure. “The main surface 131” and “the main surface 132” of the substrate 130A in Embodiment 1 correspond to “a first main surface” and “a second main surface”, respectively, of the second substrate in the present disclosure. “The ground electrode GND2” and “the ground electrode GND1” in Embodiment 1 correspond to “a first ground electrode” and “a second ground electrode” in the present disclosure. “The radiating element 121B” and “the radiating element 121A” in Embodiment 1 correspond to “a first radiating element” and “a second radiating element”, respectively, in the present disclosure. “The conductive member 150” and “the conductive member 155” in Embodiment 1 correspond to “a ground via” and “a signal via”, respectively, in the present disclosure. “The power supply line 141B” in Embodiment 1 corresponds to “a first power supply line” in the present disclosure. “The side surface 137” in Embodiment 1 corresponds to “a first side surface” in the present disclosure.

### Modification Example 1

The description of the antenna module 100 in Embodiment 1 was based on a case in which each radiating element is a patch antenna having a flat plate shape. The following describes Modification Example 1 in which linear antennas are used as radiating elements.

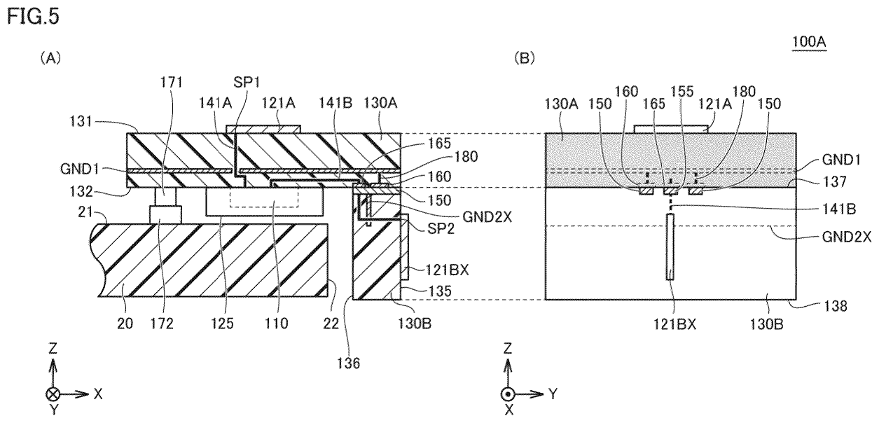

FIG. 5 illustrates a side transparent view (the left figure (A)) of an antenna module 100A of Modification Example 1 as viewed in the Y-axis direction and a side view (the right figure (B)) in the X-axis direction. The antenna module 100A has a configuration in which the radiating element 121B of the antenna module 100 of Embodiment 1 is replaced with a radiating element 121BX. In addition, the ground electrode GND2 located in the substrate 130B is replaced with a ground electrode GND2X. The other components are the same as or similar to those of the antenna module 100, and the repetitive description of the same or similar components is omitted.

The radiating element 121BX is a linear electrode extending in the Z-axis direction, and its end portion in the positive direction of the Z-axis is connected to the power supply line 141B. The ground electrode GND2X extends from the side surface 137 of the substrate 130B to the position corresponding to the power supply point SP2 of the radiating element 121BX. With the ground electrode GND2X, the power supply line 141B in the substrate 130B functions as a microstrip line.

This configuration enables the radiating element 121BX to radiate radio waves in all directions in the XY plane. Note that in the case in which the ground electrode extends across the entire surface of the substrate 130B as with the ground electrode GND2, the radiating element 121BX radiates radio waves in the X-axis direction.

Also, in the case in which a linear antenna is used as a radiating element as described above, the antenna module can be downsized because the substrate 130B is connected to the substrate 130A by using side vias.

Although FIG. 5 is based on an example in which a monopole antenna is used as the radiating element 121BX located on the substrate 130B, alternatively, it may be a dipole antenna. The radiating element 121A of the substrate 130A also may be a linear antenna.

“The radiating element 121BX” in the modification example corresponds to “a first radiating element” in the present disclosure. “The ground electrode GND2X” in the modification example corresponds to “a first ground electrode” in the present disclosure.

### Modification Example 2

The following describes a configuration of Modification Example 2 in which the SiP module 125 and the connector 171 are located on the substrate 130B.

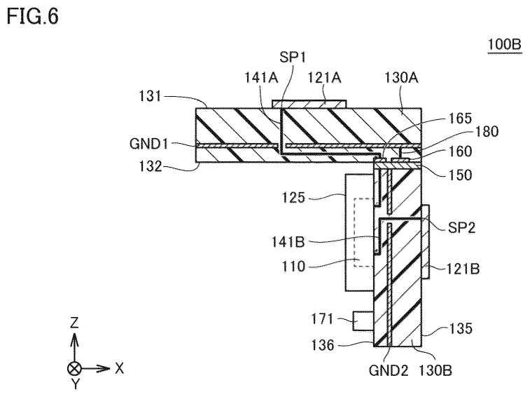

FIG. 6 is a side transparent view of an antenna module 100B of Modification Example 2 as viewed in the Y-axis direction. In the antenna module 100B, the SiP module 125 and the connector 171 are located on the main surface 136 of the substrate 130B. In this case, the power supply line 141A for supplying high frequency signals to the radiating element 121A of the substrate 130A extends from the substrate 130B to the substrate 130A via the conductive member 155.

Also, in the case of Modification Example 2, the antenna module can be downsized because the substrate 130B is connected to the substrate 130A by using side vias.

### Modification Example 3

The following describes a configuration of Modification Example 3 in which the radiating element 121B on the substrate 130B is positioned closer to the substrate 130A.

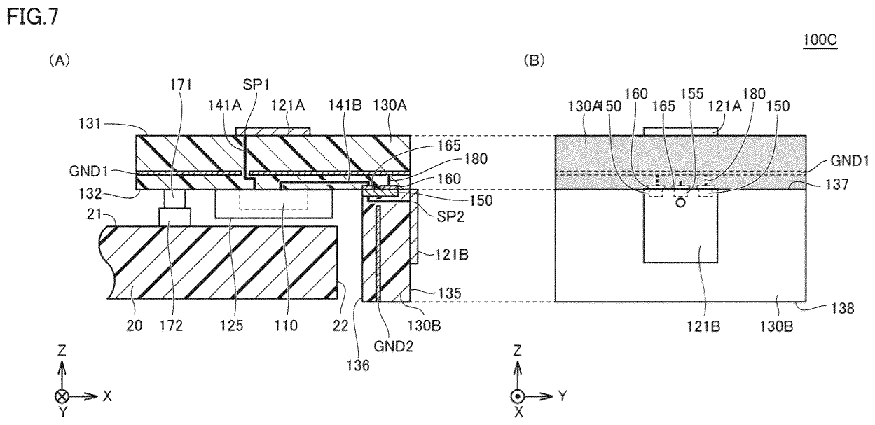

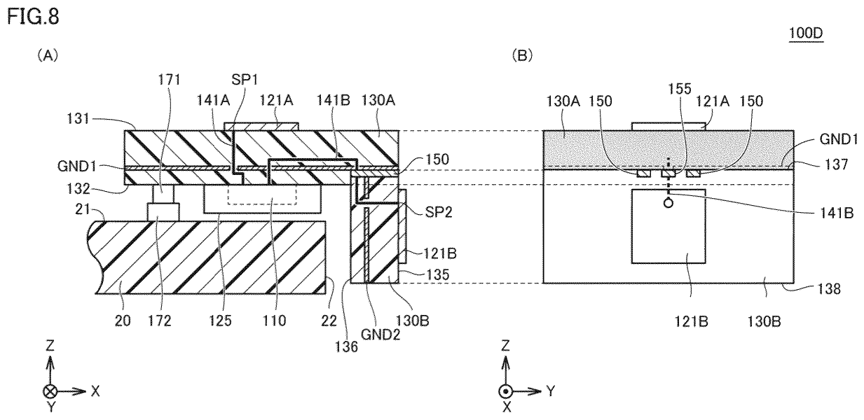

FIG. 7 illustrates a side transparent view (the left figure (A)) of an antenna module 100C of Modification Example 3 as viewed in the Y-axis direction and a side view (the right figure (B)) in the X-axis direction. In the antenna module 100C, the radiating element 121B is positioned in the positive direction of the Z-axis, compared with that in the antenna module 100 in FIG. 3. More specifically, the side of the radiating element 121B in the positive direction of the Z-axis is at the position of the side surface 137 of the substrate 130B. In plan view in the X-axis direction, at least part of the side vias (the conductive members 150 and 155) overlap the radiating element 121B.

Regarding patch antennas, in general, when the area of the ground electrode is large enough for the radiating element, the antenna gain tends to be high, and when the area of the ground electrode is small, in particular, in the polarization direction, the antenna gain tends to be low.

By shifting the position of the radiating element 121B in the direction of the substrate 130A as in the antenna module 100C, the area of the portion of the ground electrode GND2 positioned in the negative direction of the Z-axis relative to the radiating element 121B can be larger than in the antenna module 100 in FIG. 3. This improves the antenna gain of the radiating element 121B.

Alternatively, by shifting the position of the radiating element 121B in the direction of the substrate 130A in a state in which the area of the portion of the ground electrode GND2 positioned in the negative direction of the Z-axis relative to the radiating element 121B is almost equal to that in the antenna module 100, the dimension in the Z-axis direction may be reduced while maintaining the radiation characteristics. This leads to a reduction in the size and height of the device.

### Modification Example 4

The following describes Modification Example 4 having another configuration of the connection portion between the substrate 130A and the substrate 130B.

FIG. 8 illustrates a side transparent view (the left figure (A)) of an antenna module 100D of Modification Example 4 as viewed in the Y-axis direction and a side view (the right figure (B)) in the X-axis direction. In the antenna module 100D, the substrate 130A has a recess at the portion connected to the substrate 130B, and the substrate 130B is located such that the side surface 137 of the substrate 130B is in the recess.

More specifically, in the example of FIG. 7, the recess is formed such that an end portion of the lower surface 132 of the substrate 130A in the positive direction of the X-axis is recessed to the position of the ground electrode GND1. The conductive members 150 for the ground electrode are in contact with the ground electrode GND1. Note that part of the ground electrode GND1 corresponding to the position of the conductive member 155 for the power supply line is removed, and the conductive member 155 is connected to the power supply line 141B.

The configuration mentioned above reduces the dimension in the Z-axis direction, leading to a reduction in the size and height of the device. Since the substrate 130B is fitted into the recess, the positioning accuracy when the substrate 130B is mounted onto the substrate 130A is improved.

### Modification Example 5

The following describes a configuration of Modification Example 5 in which one substrate has a protruding portion extending along its main surface to improve the radiation characteristics or to reduce the height.

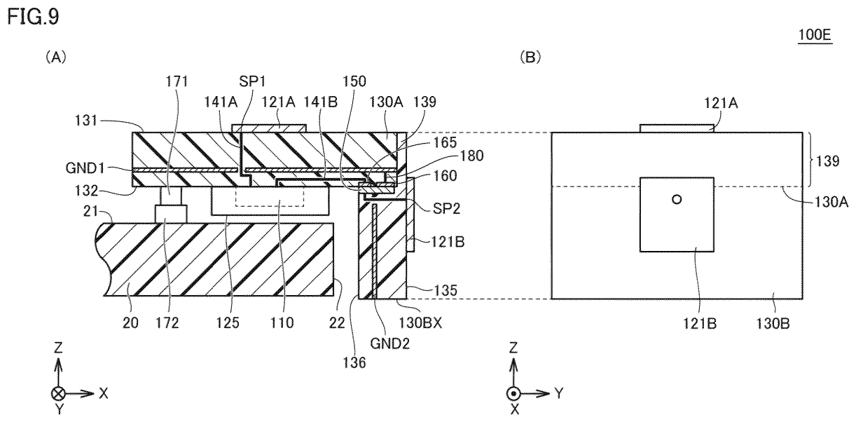

FIG. 9 illustrates a side transparent view (the left figure (A)) of an antenna module 100E of Modification Example 5 as viewed in the Y-axis direction and a side view (the right figure (B)) in the X-axis direction. The antenna module 100E has a configuration in which the substrate 130B of the antenna module 100 in FIG. 3 is replaced with a substrate 130BX.

The substrate 130BX includes a protruding portion 139 protruding in the positive direction of the Z-axis along the main surface 135. The dimension (the thickness) of the protruding portion 139 in the X-axis direction is less than the dimension of the portion other than the protruding portion 139 in the substrate 130BX. In other words, at the protruding portion 139, a recess is formed in the main surface 136.

The substrate 130BX is located such that the protruding portion 139 covers at least part of the side surface of the substrate 130A facing the positive direction of the X-axis. The conductive members 150 and 155 are located in the portion of the substrate 130B that is in contact with the lower surface 132 of the substrate 130A, and the ground electrode GND2 and the power supply line 141B are electrically connected to the substrate 130A with the conductive members 150 and 155 interposed therebetween. Note that in the example of FIG. 9, the protruding portion 139 covers the entire side surface of the substrate 130A.

In addition, the radiating element 121B of the substrate 130BX is located at a position where the radiating element 121B overlaps part of the substrate 130A and at least part of the conductive members 150 and 155 in plan view in the X-axis direction.

This configuration increases the area of the portion of the ground electrode GND2 positioned in the negative direction of the Z-axis relative to the radiating element 121B, improving the antenna gain of the radiating element 121B. Alternatively, by reducing the dimension of the substrate 130BX in the Z-axis direction, the size and height of the device can be reduced.

### Modification Example 6

The following describes a configuration of Modification Example 6 to reduce the height of the device by fitting a protruding portion of one substrate into a recess of the other substrate.

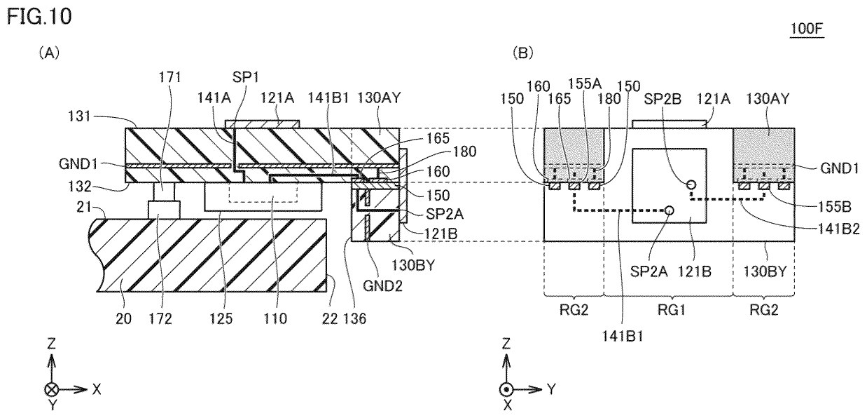

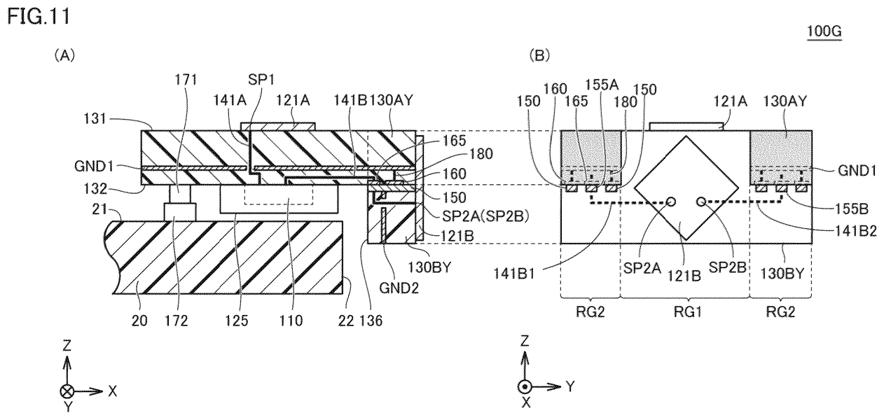

FIG. 10 illustrates a side transparent view (the left figure (A)) of an antenna module 100F of Modification Example 6 as viewed in the Y-axis direction and a side view (the right figure (B)) in the X-axis direction. The antenna module 100F includes a substrate 130AY having a lower surface 132 whose end portion in the positive direction of the X-axis has a plurality of recesses recessed in the normal direction of the lower surface 132 and extending in the Y-axis direction. A substrate 130BY includes a first region RG1 including a protruding portion having a shape configured to be fitted into the recess of the substrate 130AY and second regions RG2 configured to be in contact with the lower surface 132 of the substrate 130AY in the state in which the protruding portion is fitted into the recess. In other words, the substrate 130BY is approximately T-shaped in plan view in the X-axis direction.

The radiating element 121B is located in the first region RG1 of the substrate 130BY. Part of the radiating element 121B overlaps the substrate 130AY in plan view in the X-axis direction. In each of the two second regions RG2 of the substrate 130BY, the conductive members 150 and 155 are located on the side surface facing the positive direction of the Z-axis, and the conductive members 150 and 155 connect the substrate 130AY and the substrate 130BY.

The antenna module 100F is a so-called dual-polarized antenna module in which the radiating element 121B has two power supply points SP2A and SP2B. The power supply point SP2A is positioned in the negative direction of the Z-axis relative to the center of the radiating element 121B. The power supply point SP2B is positioned in the positive direction of the Y-axis relative to the center of the radiating element 121B. The power supply point SP2A is supplied with high frequency signals through a power supply line 141B1 via the conductive member 155A of one of the second regions RG2. The power supply point SP2B is supplied with high frequency signals through a power supply line 141B2 via the conductive member 155B of the other of the second regions RG2. Note that being a dual-polarized antenna module is not indispensable in Modification Example 6, the configuration of Modification Example 6 can be applied to single polarized antenna modules such as the antenna modules 100 to 100E.

This configuration reduces the dimension of the substrate 130BY in the Z-axis direction, leading to a reduction in the size and height of the device. In addition, the connection by the protruding portion of the substrate 130BY being fitted into the recess of the substrate 130AY improves the positioning accuracy of the substrate 130BY and also increases the connection strength of the two substrates.

“The substrate 130BY” and “the substrate 130AY” in Modification Example 6 correspond to “a first substrate” and “a second substrate”, respectively, in the present disclosure. “The power supply line 141B1” and “the power supply line 141B2” in Modification Example 6 correspond to “a first power supply line” and “a second power supply line”, respectively, in the present disclosure. “The conductive member 155A” and “the conductive member 155B” in Modification Example 6 correspond to “a first signal via” and “a second signal via”, respectively, in the present disclosure. “The power supply point SP2A” and “the power supply point SP2B” in Modification Example 6 correspond to “a first power supply point” and “a second power supply point”, respectively, the present disclosure.

### Modification Example 7

The following describes a configuration of Modification Example 7 in which the placemen manner of the radiating element 121B is changed in a dielectric substrate having the same or a similar structure as in the antenna module 100F of Modification Example 6.

FIG. 11 illustrates a side transparent view (the left figure (A)) of an antenna module 100G of Modification Example 7 as viewed in the Y-axis direction and a side view (the right figure (B)) in the X-axis direction. In the antenna module 100G, as in the antenna module 100F, the substrate 130BY includes the first region RG1 and the second regions RG2, and the substrate 130BY is located such that the protruding portion in the first region RG1 of the substrate 130BY is fitted into the recess of the substrate 130AY.

The radiating element 121B located in the first region RG1 is placed such that each side is inclined with respect to the Y-axis and the Z-axis. In the example of FIG. 11, the polarization direction of the radio waves radiated from the radiating element 121B is at 45° with respect to the Y-axis. In other words, the power supply point SP2A is positioned in the negative direction of the Y-axis (a first direction) relative to the center of the radiating element 121B, and the power supply point SP2B is positioned in the positive direction of the Y-axis (a second direction) relative to the center of the radiating element 121B. The extending direction of each side of the radiating element 121B intersects the first and second directions mentioned above.

The placement manner of the radiating element 121B enables the area of the ground electrode GND2 approximately to the same degree to be allocated in each polarization direction, which improves the antenna gain.

### Modification Example 8

The following describes a configuration of Modification Example 8 in which the conductive member 155 for the power supply line is used as a stub to match the impedance.

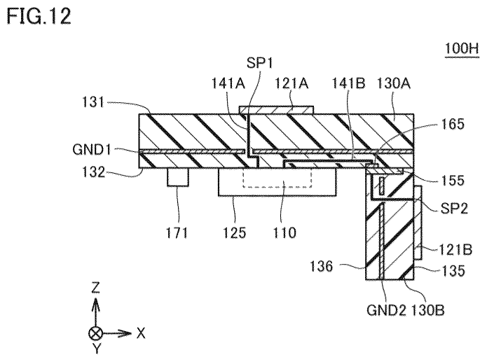

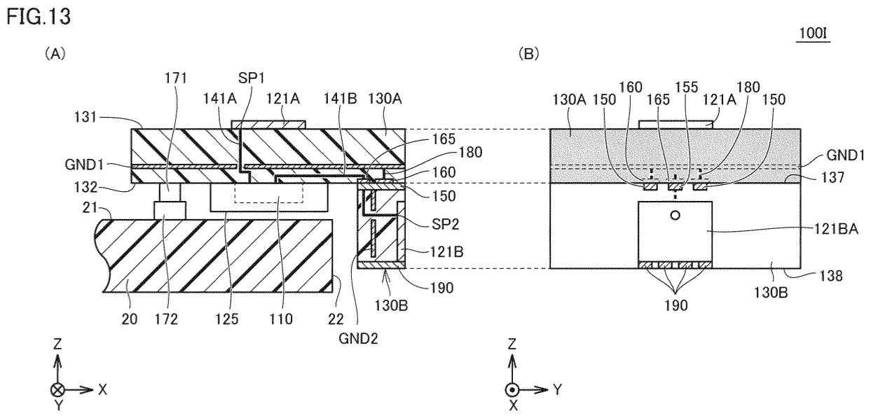

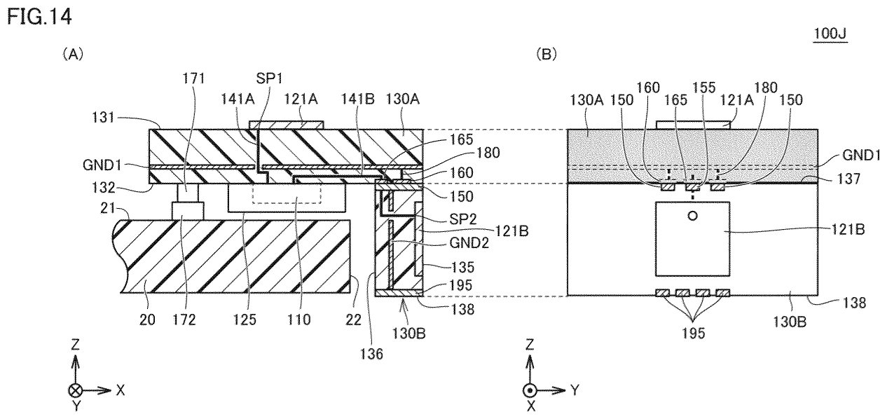

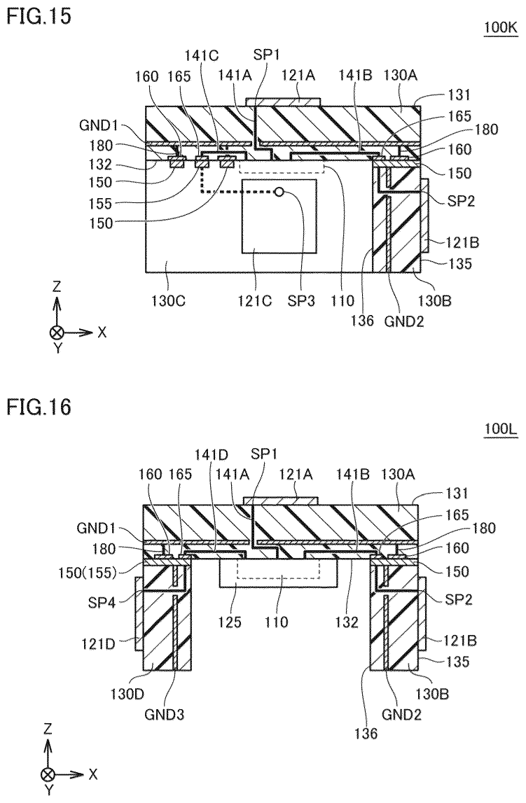

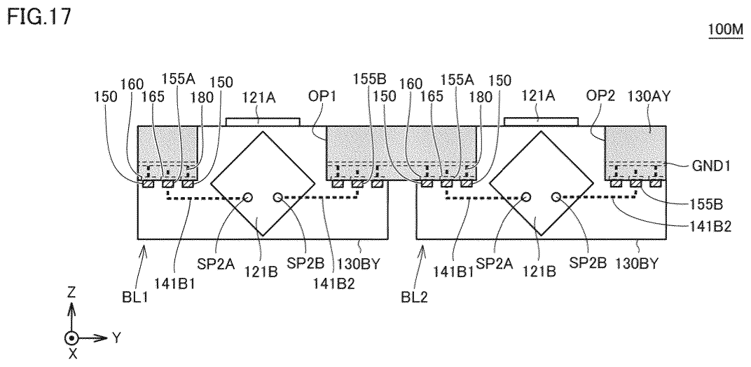

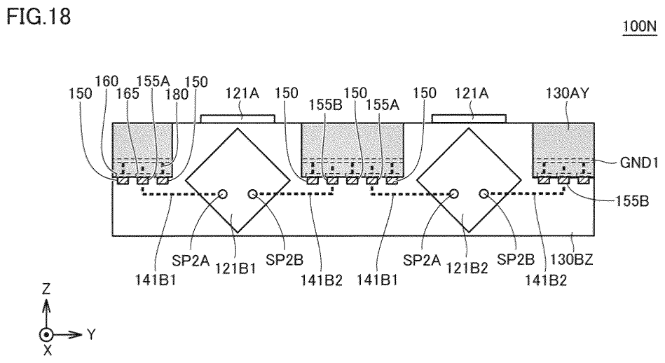

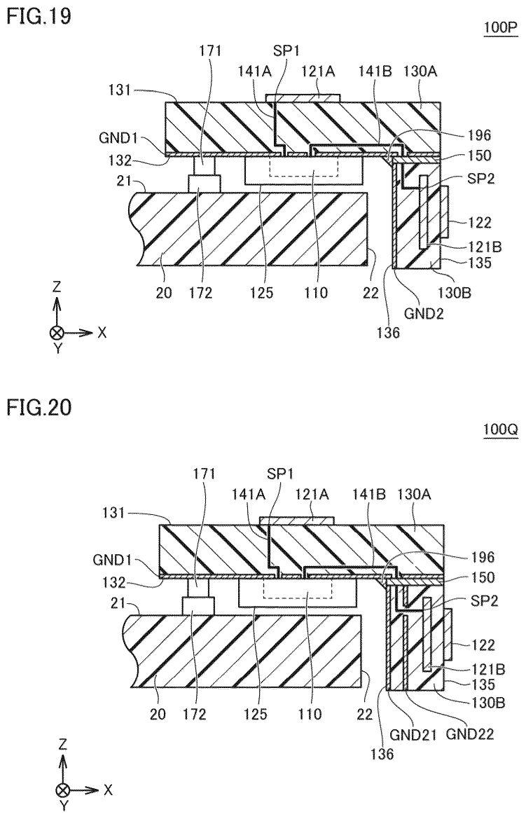

FIG. 12 is a side transparent view of an antenna module 100H of Modification Example 8 as viewed in the Y-axis direction. Note that in FIG. 12, the illustration of the conductive members 150 for the ground electrode is omitted to describe the conductive member 155 for the power supply line.

The antenna module 100H basically has the same or a similar configuration as the antenna module 100 in FIG. 3, and the power supply line 141B for the radiating element 121B extends from the substrate 130A, passes through the conductive member 155, and is connected to the radiating element 121B of the substrate 130B.

In this configuration, the conductive member 155 extends in the X-axis direction which intersects the extending direction of the power supply line 141B. With this configuration, the conductive member 155 not only functions as a connection terminal but also functions as a stub by adjusting its length in the X-axis direction. The end portion of the conductive member 155 on the open side may extend through to the main surface 135 of the substrate 130B or may be positioned inside the substrate 130B, depending on the necessary length. In the case in which the conductive member 155 extends through the substrate 130B, the directivity of the radio waves radiated from the radiating element 121B can be adjusted because the conductive member 155 functions as a shielding wall against radio-wave radiation to the substrate 130A. In the case in which the conductive member 155 does not extend through the substrate 130B, the effect as a shielding wall as mentioned above is small. Hence, the coverage range of the radiating element 121B is larger than in the case in which the conductive member 155 extends through the substrate 130B.

### Embodiment 2

The description of Embodiment 1 was based on configurations in which side vias are used for the electrical connection between substrates. The following describes a configuration of Embodiment 2 in which side vias are used as part of a radiating element.

FIG. 13 illustrates a side transparent view (the left figure (A)) of an antenna module 100I according to Embodiment 2 as viewed in the Y-axis direction and a side view (the right figure (B)) in the X-axis direction. The antenna module 100I has a configuration in which the substrate 130B has conductive members 190, in addition to the configuration of the antenna module 100 of Embodiment 1 illustrated in FIG. 3. In addition, the radiating element 121B is replaced with a radiating element 121BA. In FIG. 13, the repetitive description of the same or similar components as in FIG. 3 is omitted.

As illustrated in FIG. 13, the conductive members 190, having basically the same or a similar configuration as the conductive members 150 and 155, are exposed on the side surface 138 of the substrate 130B facing the negative direction of the Z-axis. The conductive members 190 are electrically connected to the end surface of the radiating element 121BA on the side surface 138 side and are not connected to the ground electrode GND2. The conductive members 190 with the configuration mentioned above function as part of the radiating element. Although FIG. 13 is based on an example including four conductive members 190, the number of conductive members 190 is not limited to this example and needs only to be one or more.

Given that λ is the wavelength of the radio wave to be radiated, the dimension of the radiating element 121BA and the dimension of the conductive members 190 are determined such that the sum of the dimension of the radiating element 121BA in the Z-axis direction and the dimension of the conductive members 190 in the X-axis direction is equal to λ/2. Providing the conductive members 190 that function as part of the radiating element as described above reduces the dimension of the radiating element 121BA in the Z-axis direction. This in turn reduces the dimension of the substrate 130B in the Z-axis direction, leading to a reduction in the size and height of the device.

“The side surface 138” in Embodiment 2 corresponds to “a second side surface” in the present disclosure. “The conductive member 190” in Embodiment 2 corresponds to “a second conductive member” in the present disclosure.

### Embodiment 3

The following describes a configuration of Embodiment 3 in which side vias are used as part of the ground electrode.

FIG. 14 illustrates a side transparent view (the left figure (A)) of an antenna module 100J according to Embodiment 3 as viewed in the Y-axis direction and a side view (the right figure (B)) in the X-axis direction. In the antenna module 100J, as in the antenna module 100I of Embodiment 2, the side surface 138 of the substrate 130B has conductive members 195.

The conductive members 195 also basically have the same as or a similar configuration as the conductive members 150 and 155. However, the conductive members 195 are not connected to the radiating element 121B but are electrically connected to the ground electrode GND2 in the substrate 130B. Specifically, the conductive members 195 function as part of the ground electrode GND2. The end portions of the conductive members 195 in the positive direction of the X-axis are positioned on the main surface 135 side relative to the ground electrode GND2. Thus, the electric field lines generated from the end surface of the radiating element 121B on the side surface 138 side are more likely to be coupled to the conductive members 195 than to the ground electrode GND2.

In the case in which the area of the ground electrode GND2 in the polarization direction of the radiating element is small as mentioned above, the antenna gain tends to be low. However, by using the conductive members 195 to bring the ground electrode GND2 practically closer to the radiating element 121B, the leakage of electric field lines to the back face of the ground electrode GND2 can be reduced even if the area of the ground electrode GND2 in the polarization direction is small. This mitigates the decrease in the antenna gain.

Alternatively, by providing such conductive members connected to the ground electrode GND2, the dimension of the portion of the substrate 130B on the side surface 138 side relative to the radiating element 121B can be reduced, and hence the dimension of the substrate 130B in the Z-axis direction can be reduced. This leads to a reduction in the size and height of the device.

“The conductive member 195” in Embodiment 2 corresponds to “a third conductive member” in the present disclosure.

### Embodiment 4

The description of the embodiments described above and their modification examples was based on the configurations of the antenna modules capable of radiating radio waves in two different directions. The following describes a configuration of Embodiment 4 in which the features of the present disclosure are applied to an antenna module capable of radiating radio waves in three different directions.

FIG. 15 is a side transparent view of an antenna module 100K of according to Embodiment 4 as viewed in the Y-axis direction. The antenna module 100K further includes a substrate 130C having a radiating element 121C, in addition to the configuration of the antenna module 100 of Embodiment 1 in FIG. 3.

More specifically, the substrate 130C has a flat plate shape whose normal direction corresponds to the Y-axis direction, and in FIG. 15, the radiating element 121C having a flat plate shape is located on the main surface of the substrate 130C facing the negative direction of the Y-axis. The substrate 130C is connected to the substrate 130A at an end portion of the substrate 130A in the negative direction of the Y-axis. The side surface of the substrate 130C connected to the substrate 130A has conductive members 150 and 155, and these conductive members 150 and 155 are connected to electrode pads 160 and 165, respectively, of the substrate 130A by using solder or other methods. This configuration establishes the electrical connection between the substrate 130A and the substrate 130C and also fixes the substrate 130C to the substrate 130A.

The conductive members 150 are connected to a ground electrode (not illustrated) in the substrate 130C, and the connection between the conductive members 150 and the electrode pads 160 connects the ground electrode in the substrate 130C and the ground electrode GND1 of the substrate 130A. In addition, by connecting the conductive member 155 and the electrode pad 165, high frequency signals from the RFIC 110 in the SiP module 125 are conveyed to the radiating element 121C through a power supply line 141C. The power supply line 141C is connected to a power supply point SP3 positioned in the positive direction of the Z-axis relative to the center of the radiating element 121C. When high frequency signals are supplied to the power supply point SP3, the radiating element 121C radiates radio waves with the polarization direction along the Z-axis in the negative direction of the Y-axis.

In the antenna module including a dielectric substrate having three substrates each having a radiating element as described above, the use of the side vias to electrically connect the substrates reduces the size and height of the device and allows radio waves to be radiated in three different directions.

“The substrate 130C” in Embodiment 4 corresponds to “a third substrate” in the present disclosure. “The radiating element 121C” in Embodiment 4 corresponds to “a third radiating element” in the present disclosure. Each of “the conductive members 150 and 155” located in the substrate 130C in Embodiment 4 corresponds to “a fourth conductive member” in the present disclosure.

### Modification Example 9

The following describes Modification Example 9 which is an example of another configuration of an antenna module capable of radiating radio waves in three directions.

FIG. 16 is a side transparent view of an antenna module 100L according to Modification Example 9 as viewed in the Y-axis direction. The antenna module 100L includes a substrate 130D having a radiating element 121D, in addition to the configuration of the antenna module 100 of Embodiment 1 in FIG. 3.

More specifically, the substrate 130D has a flat plate shape whose normal direction corresponds to the X-axis direction, and the radiating element 121D having a flat plate shape is located on the main surface of the substrate 130D facing the negative direction of the X-axis. The substrate 130D is connected to the substrate 130A at an end portion of the substrate 130A in the negative direction of the X-axis. The side surface of the substrate 130D connected to the substrate 130A has conductive members 150 and 155, and these conductive members 150 and 155 are connected to electrode pads 160 and 165, respectively, of the substrate 130A by using solder or other methods. This configuration establishes the electrical connection between the substrate 130A and the substrate 130D and also fixes the substrate 130D to the substrate 130A.

The conductive members 150 are connected to a ground electrode GND3 in the substrate 130D, and the connection between the conductive members 150 and the electrode pads 160 connects the ground electrode GND3 in the substrate 130D and the ground electrode GND1 of the substrate 130A. In addition, by connecting the conductive member 155 and the electrode pad 165, high frequency signals from the RFIC 110 in the SiP module 125 are conveyed to the radiating element 121D through a power supply line 141D. The power supply line 141D is connected to a power supply point SP4 positioned in the positive direction of the Z-axis relative to the center of the radiating element 121D. When high frequency signals are supplied to the power supply point SP4, the radiating element 121D radiates radio waves with the polarization direction along the Z-axis in the negative direction of the X-axis.

Also, in the configuration of the antenna module of Modification Example 9, the use of the side vias to electrically connect the substrates as described above reduces the size and height of the device and also makes it possible to radiate radio waves in three different directions.

“The substrate 130D” in Modification Example 9 corresponds to “a third substrate” in the present disclosure. “The radiating element 121D” in Modification Example 9 corresponds to “a third radiating element” in the present disclosure. Each of “the conductive members 150 and 155” of the substrate 130D in Modification Example 9 corresponds to “a fourth conductive member” in the present disclosure.

### Embodiment 5

The following describes Embodiment 5 which is an example of an array antenna having the substrate configuration shown in Modification Example 7 in FIG. 11.

FIG. 17 is a side view of an antenna module 100M of according to Embodiment 5 as viewed in the X-axis direction. The antenna module 100M has a configuration in which antenna blocks BL1 and BL2 each including an approximately T-shaped substrate and a radiating element located on the substrate are respectively fitted into recesses OP1 and OP2 formed in the substrate 130AY so as to extend in the Y-axis direction.

On each of the antenna blocks BL1 and BL2, as in FIG. 11, a radiating element 121B is located on a main surface of the substrate 130BY so as to be inclined with respect to the X-axis and the Z-axis. Power supply points SP2A and SP2B of each radiating element 121B are supplied with high frequency signals through power supply lines 141B1 and 141B2. The power supply point SP2A of each radiating element 121B is supplied with high frequency signals via a conductive member 155A located in the negative direction of the Y-axis relative to the radiating element 121B. The power supply point SP2B of each radiating element 121B is supplied with high frequency signals via a conductive member 155B located in the positive direction of the Y-axis relative to the radiating element 121B.

Also, in the array antenna having a configuration including a plurality of antenna blocks as mentioned above, the positioning accuracy and the connection strength of each antenna block may be improved while reducing the size and height of the device.

### Modification Example 10

The following describes Modification Example 10 which is an example in which the plurality of antenna blocks in the antenna module 100M of Embodiment 5 are formed by using one substrate.

FIG. 18 is a side view of an antenna module 100N according to Modification Example 10 as viewed in the X-axis direction. The antenna module 100N includes a substrate 130BZ having protruding portions adapted to the plurality of recesses of the substrate 130AY, and radiating elements 121B1 and 121B2 (hereinafter also collectively referred to as “radiating elements 121B”) are located on the two protruding portions.

Each radiating element 121B is inclined with respect to the Y-axis and the Z-axis on the substrate 130BZ, and high frequency signals are supplied to the power supply points SP2A and SP2B through the power supply lines 141B1 and 141B2. Each power supply point SP2A is provided with high frequency signals via the corresponding conductive member 155A, and each power supply point SP2B is provided with high frequency signals via the corresponding conductive member 155A.

Also, as described in Embodiment 1, each of the conductive member 155A and 155B is located between two conductive members 150 for the ground electrode in plan view in the X-axis direction so as to function as a coplanar line. Regarding the conductive member 155B for the radiating element 121B1 and the conductive member 155A for the radiating element 121B2 located in a region between the two radiating elements 121B1 and 121B2, if each of the conductive members 155A and 155B is individually provided with conductive members 150 as in the antenna module 100M of Embodiment 5, four conductive members 150 would be necessary in total, requiring a larger area for arranging the conductive members 150 and 155.

In Modification Example 10, in the region between the radiating element 121B1 and the radiating element 121B2, one of the conductive members 150 provided for each of the conductive members 155A and 155B is shared. Specifically, as illustrated in FIG. 18, three conductive members 150 and two conductive members 155A and 155B are in the region between the radiating elements, and one conductive member 150 is located between the conductive member 155A and the conductive member 155B.

Since the adjacent radiating elements share a conductive member 150 as described above, the dimension of the substrates 130AY and 130BY in the Y-axis direction may be reduced, leading to a reduction in the size of the array antenna.

“The substrate 130AY” and “the substrate 130BZ” in Modification Example 10 correspond to “a first substrate” and “a second substrate”, respectively, in the present disclosure. “The radiating element 121B1” and “the radiating element 121B2” in Modification Example 10 correspond to “a first radiating element” and “a fourth radiating element”, respectively, in the present disclosure. “The power supply line 141B2” and “the conductive member 155B” for the radiating element 121B1 in Modification Example 10 correspond to “a first power supply line” and “a first signal via”, respectively, in the present disclosure. “The power supply line 141B1” and “the conductive member 155A” for the radiating element 121B2 in Modification Example 10 correspond to “a fourth power supply line” and “a fourth signal via”, respectively, in the present disclosure.

### Modification Example 11

The following describes Modification Example 11 which is a first example of another arrangement of the ground electrodes GND1 and GND2 of the substrates 130A and 130B in the antenna module 100 of Embodiment 1.

FIG. 19 is a side transparent view of an antenna module 100P according to Modification Example 11 as viewed in the Y-axis direction. In the antenna module 100P, the ground electrodes GND1 and GND2 of the substrates 130A and 130B are respectively located on the main surfaces (specifically, the main surfaces 132 and 136), of the substrates 130A and 130B facing the mounting substrate 20.

Since the ground electrode GND1 of the substrate 130A is located on the main surface 132, the conductive members 150 formed on the substrate 130B can be directly connected to the ground electrode GND1. A conductive fillet 196 may be provided at the portion where the main surface 132 of the substrate 130A is in contact with the main surface 136 of the substrate 130B to connect the ground electrode GND1 and the ground electrode GND2.

In the antenna module 100P, the radiating element 121B is located in an inner layer of the substrate 130B, and a radiating element 122, which is a parasitic element, is additionally located on the main surface 135 of the substrate 130B. Providing such a parasitic element as mentioned above increases the frequency bandwidth of the radio waves radiated from the radiating element 121B.

### Modification Example 12

The following describes Modification Example 12 which is a second example of another arrangement of the ground electrodes GND1 and GND2 of the substrates 130A and 130B in the antenna module 100 of Embodiment 1.

FIG. 20 is a side transparent view of an antenna module 100Q according to Modification Example 12 as viewed in the Y-axis direction. In the antenna module 100Q, the ground electrode GND1 of the substrate 130A is located on the main surface 132 facing the mounting substrate 20. In the substrate 130B, a ground electrode GND21 is located on the main surface 136, and a ground electrode GND22 is located between the ground electrode GND21 and the radiating element 121B. In the substrate 130B, the power supply line 141B is located in the dielectric layer between the ground electrode GND21 and the ground electrode GND22.

In the antenna module 100 of Embodiment 1 and the antenna module 100P of Modification Example 11, the power supply line 141B, together with the ground electrode GND2, forms a microstrip line. However, in the antenna module 100Q of Modification Example 12, the power supply line 141B, together with the ground electrodes GND21 and GND22, forms a stripline.

Also, in the antenna module 100Q, the radiating element 122, which is a parasitic element, may be provided on the main surface 135 of the substrate 130B as in the antenna module 100P of Modification Example 11.

### Aspects

It is understood by those skilled in the art that the plurality of exemplary embodiments described above are specific examples of the following aspects.

(Section 1) A substrate structural unit according to an aspect includes a first substrate, a second substrate, and at least one first conductive member. Each of the first substrate and the second substrate includes a first main surface and a second main surface opposed to each other and side surfaces connecting the first main surface and the second main surface. The first conductive member is exposed on a side surface of the first substrate. The first substrate is attached to the second substrate such that the normal direction of the first main surface of the first substrate differs from the normal direction of the first main surface of the second substrate. The first substrate is electrically connected to the second substrate by the at least one first conductive member.

(Section 2) An antenna module according to an aspect includes a first substrate, a second substrate, a first radiating element located on or in the first substrate, and at least one first conductive member. Each of the first substrate and the second substrate includes a first main surface and a second main surface opposed to each other and side surfaces connecting the first main surface and the second main surface. The first conductive member is exposed on a first side surface of the first substrate. The first substrate is attached to the second substrate such that the normal direction of the first main surface of the first substrate differs from the normal direction of the first main surface of the second substrate. The first substrate is electrically connected to the second substrate by the at least one first conductive member.

(Section 3) The antenna module according to section 2 further includes a first ground electrode located on or in the first substrate, and a second ground electrode located on or in the second substrate. The at least one first conductive member includes a ground via connecting the first ground electrode and the second ground electrode.

(Section 4) The antenna module according to section 2 or 3 further includes a power supply circuit located on the second main surface of the second substrate, and a first power supply line. The first power supply line conveys a high frequency signal from the power supply circuit through the second substrate and the first substrate to the first radiating element. The at least one first conductive member includes a signal via connecting a portion of the first power supply line in the first substrate and a portion of the first power supply line in the second substrate.

(Section 5) The antenna module according to section 2 further includes a first ground electrode located on or in the first substrate, a second ground electrode located on or in the second substrate, and a power supply circuit located on the second main surface of the second substrate, and a first power supply line. The first power supply line conveys a high frequency signal from the power supply circuit through the second substrate and the first substrate to the first radiating element. The at least one first conductive member includes a signal via and first and second ground vias connecting the first ground electrode and the second ground electrode. The signal via connects a portion of the first power supply line in the first substrate and a portion of the first power supply line in the second substrate. The signal via is located between the first ground via and the second ground via.

(Section 6) In the antenna module according to any one of sections 2 to 5, the second main surface of the second substrate has a recess recessed in the normal direction of the second main surface. The first substrate is attached to the second substrate such that the first side surface is in the recess. The first substrate is electrically connected to the second substrate in the recess.

(Section 7) In the antenna module according to any one of sections 2 to 6, at least part of the at least one first conductive member overlaps the first radiating element in plan view in the normal direction of the first substrate.

(Section 8) In the antenna module according to section 2, the second main surface of the second substrate has a recess recessed in the normal direction of the second main surface. The first substrate includes a first region extending into the recess and second regions in contact with the second main surface of the second substrate. The at least one first conductive member is located in the second regions.

(Section 9) The antenna module according to section 8 further includes a power supply circuit located on the second main surface of the second substrate, a first power supply line, and a second power supply line. The first power supply line and the second power supply line convey high frequency signals from the power supply circuit through the second substrate and the first substrate to the first radiating element. The first radiating element is a patch antenna having a flat plate shape. The first radiating element includes first and second power supply points each positioned in a different direction relative to the center of the first radiating element. A high frequency signal is conveyed from the power supply circuit to the first power supply point through the first power supply line. A high frequency signal is conveyed from the power supply circuit to the second power supply point through the second power supply line.

(Section 10) In the antenna module according to section 9, the at least one first conductive member includes a first signal via and a second signal via. The first signal via connects a portion of the first power supply line in the first substrate and a portion of the first power supply line in the second substrate. The second signal via connects a portion of the second power supply line in the first substrate and a portion of the second power supply line in the second substrate. In plan view in the normal direction of the first substrate, the first signal via is located in the second region positioned in a first direction relative to the first radiating element, and the second signal via is located in the second region positioned in a second direction, opposite to the first direction, relative to the first radiating element.

(Section 11) In the antenna module according to section 10, the first radiating element has a rectangular shape having a first side and a second side adjacent to each other. Extending directions of the first side and the second side intersect the first direction or the second direction. The first power supply point is positioned in the first direction relative to the center of the first radiating element. The second power supply point is positioned in the second direction relative to the center of the first radiating element.

(Section 12) In the antenna module according to any one of sections 2 to 11, at least part of the first radiating element overlaps the second substrate in plan view in the normal direction of the first substrate.

(Section 13) In the antenna module according to any one of sections 2 to 7, the first substrate includes a protruding portion extending along the first main surface of the first substrate and covering part of a side surface of the second substrate.

(Section 14) The antenna module according to section 2 further includes at least one second conductive member located on a second side surface of the first substrate, opposed to the first side surface, and connected to the first radiating element.

(Section 15) The antenna module according to section 3 further includes at least one third conductive member located on a second side surface of the first substrate, opposed to the first side surface, and connected to the first ground electrode.

(Section 16) In the antenna module according to section 4, the signal via protrudes from the first power supply line in a direction intersecting an extending direction of the first power supply line.

(Section 17) The antenna module according to any one of sections 2 to 16 further includes a second radiating element located on or in the second substrate.

(Section 18) The antenna module according to any one of sections 2 to 17 further includes a third substrate connected to the second substrate, a third radiating element located on or in the third substrate, and at least one fourth conductive member. The fourth conductive member is exposed on a side surface of the third substrate. The third substrate is electrically connected to the second substrate by the at least one fourth conductive member.

(Section 19) The antenna module according to section 2 further includes a first ground electrode located on or in the first substrate, a second ground electrode located on or in the second substrate, a fourth radiating element, a power supply circuit located on the second main surface of the second substrate, and first and fourth power supply lines. The fourth radiating element is located on or in the first substrate so as to be adjacent to the first radiating element. The first and fourth power supply lines convey high frequency signals from the power supply circuit to the first radiating element and the fourth radiating element, respectively, through the second substrate and the first substrate. The at least one first conductive member includes a ground via, a first signal via, and a fourth signal via. The ground via connects the first ground electrode and the second ground electrode. The first signal via connects a portion of the first power supply line in the first substrate and a portion of the first power supply line in the second substrate. The fourth signal via connects a portion of the fourth power supply line in the first substrate and a portion of the fourth power supply line in the second substrate. The ground via is located between the first signal via and the fourth signal via, in a region between the first radiating element and the fourth radiating element on the first side surface.

(Section 20) A communication device including the antenna module according to any one of sections 2 to 19.

It should be considered that all of the embodiments in the present disclosure are examples in all respects and hence are not restrictive. The scope of the present invention is defined not by the description of the above embodiments but by the claims, and is intended to include all modifications within the scope of the claims and the equivalents thereof.

### REFERENCE SIGNS LIST

10 COMMUNICATION DEVICE
20 MOUNTING SUBSTRATE
21 SURFACE
22, 137, 138 SIDE SURFACE
100, 100A to 100N, 100P, 100Q ANTENNA MODULE
105 DIELECTRIC SUBSTRATE
110 RFIC
111A to 111H, 113A to 113H, 117A, 117B SWITCH
112AR to 112HR LOW-NOISE AMPLIFIER
112AT to 112HT POWER AMPLIFIER
114A to 114H ATTENUATOR
115A to 115H PHASE SHIFTER
116A, 116B SIGNAL COMBINER/SPLITTER
118A, 118B MIXER
119A, 119B AMPLIFICATION CIRCUIT
120 ANTENNA DEVICE
121A to 121D, 121B1, 121B2, 121BA, 121BX, 122 RADIATING ELEMENT
125 SiP MODULE
130A to 130D, 130AY, 130BX, 130BY, 130BZ SUBSTRATE
131, 132, 135, 136 MAIN SURFACE
139 PROTRUDING PORTION
141A to 141D, 141B1, 141B2 POWER SUPPLY LINE
150, 155, 155A, 155B, 190, 195 CONDUCTIVE MEMBER
151, 151A THROUGH HOLE
160, 165 ELECTRODE PAD
171, 172 CONNECTOR
180 VIA
196 FILLET
200 BBIC
BL1, BL2 ANTENNA BLOCK
GND1 to GND3, GND21, GND22, GND2X GROUND ELECTRODE
OP1, OP2 RECESS
RG1 FIRST REGION
RG2 SECOND REGION
SP1 to SP4, SP2B, SP2A POWER SUPPLY POINT

1. A substrate structural unit comprising:
a first substrate and a second substrate each having a flat plate shape including a first main surface and a second main surface opposed to each other and side surfaces connecting the first main surface and the second main surface; and
at least one first conductive member exposed on a side surface of the first substrate, wherein
the first substrate is attached to the second substrate such that the normal direction of the first main surface of the first substrate differs from the normal direction of the first main surface of the second substrate, and
the first substrate is electrically connected to the second substrate by the at least one first conductive member.

2. An antenna module comprising:
a first substrate and a second substrate each having a flat plate shape including a first main surface and a second main surface opposed to each other and side surfaces connecting the first main surface and the second main surface; and
a first radiating element located on or in the first substrate; and
at least one first conductive member exposed on a first side surface of the first substrate, wherein
the first substrate is attached to the second substrate such that the normal direction of the first main surface of the first substrate differs from the normal direction of the first main surface of the second substrate, and
the first substrate is electrically connected to the second substrate by the at least one first conductive member.

3. The antenna module according to claim 2, further comprising:
a first ground electrode located on or in the first substrate; and
a second ground electrode located on or in the second substrate, wherein
the at least one first conductive member includes a ground via connecting the first ground electrode and the second ground electrode.

4. The antenna module according to claim 2, further comprising:
a power supply circuit located on the second main surface of the second substrate; and
a first power supply line that conveys a high frequency signal from the power supply circuit through the second substrate and the first substrate to the first radiating element, wherein
the at least one first conductive member includes a signal via connecting a portion of the first power supply line in the first substrate and a portion of the first power supply line in the second substrate.

5. The antenna module according to claim 2, further comprising:
a first ground electrode located on or in the first substrate;
a second ground electrode located on or in the second substrate;
a power supply circuit located on the second main surface of the second substrate; and
a first power supply line that conveys a high frequency signal from the power supply circuit through the second substrate and the first substrate to the first radiating element, wherein
the at least one first conductive member includes
first and second ground vias connecting the first ground electrode and the second ground electrode, and
a signal via connecting a portion of the first power supply line in the first substrate and a portion of the first power supply line in the second substrate, and
the signal via is located between the first ground via and the second ground via.

6. The antenna module according to claim 2, wherein
the second main surface of the second substrate has a recess recessed in the normal direction of the second main surface,
the first substrate is attached to the second substrate such that the first side surface is in the recess, and
the first substrate is electrically connected to the second substrate in the recess.

7. The antenna module according to claim 2, wherein
at least part of the at least one first conductive member overlaps the first radiating element in plan view in the normal direction of the first substrate.

8. The antenna module according to claim 2, wherein
the second main surface of the second substrate has a recess recessed in the normal direction of the second main surface,
the first substrate includes
a first region extending into the recess, and
second regions in contact with the second main surface of the second substrate, and
the at least one first conductive member is located in the second regions.

9. The antenna module according to claim 8, further comprising:
a power supply circuit located on the second main surface of the second substrate; and
first and second power supply lines that convey high frequency signals from the power supply circuit through the second substrate and the first substrate to the first radiating element, wherein
the first radiating element is a patch antenna having a flat plate shape,
the first radiating element includes first and second power supply points each positioned in a different direction relative to the center of the first radiating element,
a high frequency signal is conveyed from the power supply circuit to the first power supply point through the first power supply line, and
a high frequency signal is conveyed from the power supply circuit to the second power supply point through the second power supply line.

10. The antenna module according to claim 9, wherein
the at least one first conductive member includes
a first signal via connecting a portion of the first power supply line in the first substrate and a portion of the first power supply line in the second substrate, and
a second signal via connecting a portion of the second power supply line in the first substrate and a portion of the second power supply line in the second substrate, and
in plan view in the normal direction of the first substrate,
the first signal via is located in the second region positioned in a first direction relative to the first radiating element, and
the second signal via is located in the second region positioned in a second direction, opposite to the first direction, relative to the first radiating element.

11. The antenna module according to claim 10, wherein
the first radiating element has a rectangular shape having a first side and a second side adjacent to each other,
extending directions of the first side and the second side intersect the first direction or the second direction,
the first power supply point is positioned in the first direction relative to the center of the first radiating element, and
the second power supply point is positioned in the second direction relative to the center of the first radiating element.

12. The antenna module according to claim 2, wherein
at least part of the first radiating element overlaps the second substrate in plan view in the normal direction of the first substrate.

13. The antenna module according to claim 2, wherein
the first substrate includes a protruding portion extending along the first main surface of the first substrate and covering part of a side surface of the second substrate.

14. The antenna module according to claim 2, further comprising
at least one second conductive member located on a second side surface of the first substrate, opposed to the first side surface, and connected to the first radiating element.

15. The antenna module according to claim 3, further comprising
at least one third conductive member located on a second side surface of the first substrate, opposed to the first side surface, and connected to the first ground electrode.

16. The antenna module according to claim 4, wherein
the signal via protrudes from the first power supply line in a direction intersecting an extending direction of the first power supply line.

17. The antenna module according to claim 2, further comprising
a second radiating element located on or in the second substrate.

18. The antenna module according to claim 2, further comprising:
a third substrate connected to the second substrate;
a third radiating element located on or in the third substrate; and
at least one fourth conductive member exposed on a side surface of the third substrate, wherein
the third substrate is electrically connected to the second substrate by the at least one fourth conductive member.

19. The antenna module according to claim 3, further comprising:
a fourth radiating element located on or in the first substrate adjacent to the first radiating element;
a power supply circuit located on the second main surface of the second substrate; and
first and fourth power supply lines that convey high frequency signals from the power supply circuit to the first radiating element and the fourth radiating element, respectively, through the second substrate and the first substrate, wherein
the at least one first conductive member further includes
a first signal via connecting a portion of the first power supply line in the first substrate and a portion of the first power supply line in the second substrate, and
a fourth signal via connecting a portion of the fourth power supply line in the first substrate and a portion of the fourth power supply line in the second substrate, and
the ground via is located between the first signal via and the fourth signal via, in a region between the first radiating element and the fourth radiating element on the first side surface.

20. A communication device comprising
the antenna module according to claim 2.
